(19) United States
(12) Patent Application Publication
(10) Pub. No.: US 2019/0210254 A1
(43) Pub. Date: Jul. 11, 2019

(54) METHOD FOR MANUFACTURING PLASTIC AND RUBBER TOYS

(71) Applicant: TONGFU MANUFACTURING CO., LTD., Nanjing (CN)

(72) Inventors: Huixin YUAN, Nanjing (CN); Wen ZHANG, Nanjing (CN)

(73) Assignee: TONGFU MANUFACTURING CO., LTD., Nanjing (CN)

(21) Appl. No.: 16/231,000

(22) Filed: Dec. 21, 2018

(30) Foreign Application Priority Data
Oct. 24, 2017 (CN) 201710998137.4

(51) Int. Cl. B29C 33/38; B29C 69/02; B29C 31/04; B29C 33/42

(52) U.S. Cl. CPC B29C 33/38; B29C 69/02; B29L 2031/529; B29C 33/42; B29C 31/04

(57) ABSTRACT

An improved method for manufacturing plastic and rubber toys, including: (1) placing a fabric material into a mold for fixation according to a toy design requirement; (2) directly injecting a plastic or rubber material onto a surface of the material; (3) performing demolding to form a primary injection molded member, where the plastic and rubber material is wrapped with the fabric material; (4) when a product requires a fabric coverage rate of 100%, directly performing step (6); (5) when a product requires a fabric coverage rate of less than 100%, placing the primary injection molded member into another mold, performing secondary injection molding to form a secondary injection molded member larger than the primary; (6) placing two primary or secondary injection molded members into a mold of a hot melting machine to perform hot melt adhesion or apply a glue to complete adhesion, to form a finished product.

### BACKGROUND

### Technical Field

The present invention relates to a method for manufacturing plastic and rubber toys, in particular, to a method for manufacturing plastic and rubber toys, capable of improving quality of toys, and specifically, to an improved method for manufacturing plastic and rubber toys.

### Related Art

Plastic and rubber toys are usually products made from a polymer material through injection molding at a specific temperature under specific pressure. Restricted by the production processes, to present sophisticated and delicate patterns in terms of appearances of plastic and rubber toys, the following two methods are used at present.

The first method is to manually wrap a toy up by using a fabric material. A rubber material is used as a liner in most of such toys. The rubber material needs to be subject to treatment procedures such as internal mixer mixing, mill mixing, and vulcanization. The fabric material needs to be manually adhered, and edges thereof are sealed by using vulcanized rubber strips. Since the production processes for this product are complex, more time is consumed, and costs are increased. In addition, the rubber material is smelly, which can bring negative effects to the product sales.

The second method is to adhere a fabric material to an interior of a transparent plastic and rubber toy with a hollow structure. Although the time for manufacturing such a toy is reduced, an external plastic and rubber material needs to be transparent and needs to have good external quality. Improvements in terms of processes and raw materials also increase the costs.

### SUMMARY

The objective of the present invention is to provide an improved method for manufacturing plastic and rubber toys with regard to disadvantages in the prior art, in order to make the processes more simple and the operations easier, to enhance the strength of a product, to improve the external quality, and to reduce the costs for the product.

Technical solutions of the present invention are:

An improved method for manufacturing plastic and rubber toys is provided, including the following steps:

(1) placing a fabric material with a given texture and shape into a mold for fixation according to a toy design requirement, to ensure that the material is not displaced;

(2) closing the mold and directly injecting a plastic or rubber material onto the surface of the fabric material;

(3) performing demolding after curing and molding to form a primary injection molded member, where the plastic or rubber material is wrapped with the fabric material;

(4) when a product requires a fabric coverage rate of 100%, directly performing step (6);

(5) when a product requires a fabric coverage rate of less than 100%, placing the primary injection molded member which is mentioned in step (3) into another mold, performing secondary injection molding to form a secondary injection molded member which is larger than the primary injection molded member;

(6) placing two primary injection molded members which satisfy the requirement in step (4) or two secondary injection molded members which are mentioned in step (5) into a mold of a hot melting machine to perform hot melt adhesion or apply a glue to complete adhesion, to form a finished product.

Further, a positioning hole is arranged in the plastic or rubber part mentioned in step (2).

Further, a squeaker may be mounted inside the positioning hole.

Beneficial effects of the present invention are:

1. The product manufacturing time is effectively reduced. Production efficiency is improved. Some production processes, such as vulcanization and manual wrapping, are no longer needed. Use of a material with a strong unpleasant smell is avoided.

2. There are many options of plastic and rubber materials to choose from. No external requirement is imposed on the material that is wrapped with fabric and that is not exposed outside, so a leftover material or a plastic or rubber material in a low price may be used, to reduce costs.

3. A plastic and rubber product has high elasticity, but when it is wrapped with fabric, the strength of the product will be improved.

### DETAILED DESCRIPTION

The following further describes the present invention with reference to an embodiment.

A method for manufacturing plastic and rubber toys, for example, a rugby ball, includes the following steps:

(1) Place fabric of a specified size into a mold, to make the fabric completely cover the interior of the mold. Moreover, the size of the fabric may be slightly larger than that of the mold, so that edges of the fabric can be sandwiched by the mold, to ensure that no displacement occurs.

(2) Close the mold and directly inject the plastic or rubber material onto the surface of the fabric, to perform primary injection molding.

(3) After curing and molding for a period of time, generate a primary injection molded member, to make its cambered surfaces and side edges wrapped with the fabric. The plastic or rubber part wrapped with the fabric may be made from a relatively more economical material, to reduce costs. In addition, a positioning hole may be arranged on the plastic or rubber part, and a squeaker may be mounted inside the positioning hole. Because of covering of the fabric, the squeaker cannot be observed outside the toy, so that uniformity of an appearance is ensured, and the squeaker is protected from being damaged, to prolong the service life. Moreover, the superfluous fabric may be trimmed to ensure that the edges are neat.

(4) Since the rugby ball is designed with a fabric coverage rate which is less than 100%, place the primary injection molded member into another mold, and perform the secondary injection molding to form a secondary injection molded member, that is, a half of a rugby ball, after curing and molding. The secondary injection molded member is larger than the primary injection molded member, to endure that a fabric coverage rate of a finished product is less than 100%. Since the secondary injection is exposed to the outside, it needs to meet higher requirements such as good tactility and a fine and even surface. Therefore, the optimization of raw materials and the optimization of the processes are both needed. For example, TPE foam may be used for production to achieve better external quality. In addition, some textures may be designed on the surface to optimize the appearance.

(5) Place the cured and molded two halves of the rugby ball into a mold of a hot melting machine to perform hot melt adhesion or apply a glue to complete adhesion, to form a finished product. The finished product has elasticity, is wrapped with a fabric material to enhance its strength.

The technology of the present invention is particularly applicable to manufacturing of outdoor or floatable toys.

The parts not included in the present invention are all the same as existing technologies or may all be implemented by using existing technologies.

What is claimed is:

1. An improved method for manufacturing plastic and rubber toys, comprising the following steps:
(1) placing a fabric material with a given texture and a given shape into a mold for fixation according to a toy design requirement, to ensure that the material is not displaced;
(2) closing the mold and directly injecting a plastic or rubber material onto a surface of the fabric material;
(3) after curing and molding, performing demolding to form a primary injection molded member, wherein the plastic or rubber part is wrapped with the fabric material;
(4) when a product requires a fabric coverage rate of 100%, directly performing step (6);
(5) when a product requires a fabric coverage rate of less than 100%, placing the primary injection molded member mentioned in step (3) into another mold, performing secondary injection molding to form a secondary injection molded member which is larger than the primary injection molded member;
(6) placing two primary injection molded members which satisfy the requirement in step (4) or two secondary injection molded members which are mentioned in step (5) into a mold of a hot melting machine to perform hot melt adhesion or apply a glue to complete adhesion, to form a finished product.

2. The improved method for manufacturing plastic and rubber toys according to claim 1, wherein a positioning hole is arranged in the plastic or rubber part mentioned in step (2).

3. The improved method for manufacturing plastic and rubber toys according to claim 2, wherein a squeaker is mounted inside the positioning hole.
